(19) United States
(12) Patent Application Publication
(10) Pub. No.: US 2026/0232073 A1
(43) Pub. Date: Aug. 13, 2026

(54) METHOD FOR PRODUCING A SOLE ELEMENT AND SOLE ELEMENT

(71) Applicant: ON CLOUDS GMBH, Zürich (CH)

(72) Inventors: Renaud DESPOTS ALLAIRE, Zürich (CH); Elias Miguel ORTIZ, Zürich (CH); Maria ESCUDE, Zürich (CH)

(73) Assignee: ON CLOUDS GMBH, CH-8005 ZÜRICH (CH)

(21) Appl. No.: 19/153,509

(22) PCT Filed: Feb. 22, 2024
(86) PCT No.: PCT/EP2024/054466

§ 371 Date: Aug. 4, 2025

(30) Foreign Application Priority Data
Feb. 27, 2023 (CH) CH000200/2023

(51) Int. Cl. A43B 13/18; A43B 5/06; A43B 13/02; B29D 35/12

(52) U.S. Cl. CPC A43B 13/181; A43B 5/06; A43B 13/026; B29D 35/122

(57) ABSTRACT

A method for production and a sole element (1) includes one or more tubular channel structures (3, 4) wherein a cured fiber composition which includes fibers and a resin is introduced into the one or more tubular channel structures (3, 4).

### BACKGROUND OF THE INVENTION

### Field of the Invention

The present invention lies in the field of shoe technology, in particular running shoe technology and relates to a method for producing a sole element and a sole element.

### Discussion of Related Art

In recent years, energy recovery systems have emerged as important aspects of running shoes. The most prominent systems are rigid plates, which are typically elastic and as such often incompressible. For example, continuous carbon fiber composite plates can be incorporated in a sole structure of a running shoe. Such plates typically extend at least over the area of the metatarsal joints and are therefore preferably arranged at least in the forefoot and midfoot area of the sole structure. During tread and the subsequent roll-off movement of the foot, the rigid plate is bent and due to its elastic behavior stores energy temporarily. During push-off, the bent elastic plate then returns into its original, relatively flat shape, thereby supporting the push-off movement of the runner. Ultimately, this improves the runner's performance, for example with respect to running speed and delay of fatigue.

Most commonly, a separate rigid plate is provided which extends essentially over the complete forefoot and midfoot area and in some cases also over the heel area. Such plates are typically single piece plates being made from a suitable material, for example a fiber composite. A disadvantage of such continuous plates is that they increase the overall weight of the sole and therefore of the running shoe. However, in particular in high-performance areas and professional competition, even small weight increases can have severe consequences on the running performance and competitiveness.

Certain known energy recovery systems use plates with cut-outs to minimize the weight of the system or only use one or more separate rigid rod elements which extend in the midfoot and forefoot area. However, common problems with the latter system are the fixation of the individual rods to other elements of the sole structure and the relatively cumbersome production. Furthermore, such separated rods often show a reduced force transmission.

Furthermore, another common problem with known energy recovery systems is the restricted design freedom due to limitations in their manufacture. For example, if it is desired to adjust the specific energy recovery system to the gait and/or anatomical conditions of the foot of an individual, difficulties during manufacture occur, because most systems are traditionally injection molded and thus, the molds have to be adjusted for every single individual. In addition, many known energy recovery systems are manufactured in a way which does not allow to easily and rapidly adapt the system to the specific requirements of an individual.

### SUMMARY OF THE INVENTION

It is therefore a general object of the present invention to advance the state of the art in the field of shoe technology, in particular in energy recovery systems for shoes, and preferably to overcome the problems of the prior art fully or partly. In advantageous embodiments, a method for producing a sole element is provided, which can be easily and efficiently adapted to the specific requirements of a runner. In further advantageous embodiments, a method for producing a sole element is provided, which allows for a more efficient production and/or for greater design freedom of the produced sole element. In further advantageous embodiments, a sole element is provided which allows for returning energy to the runner and has preferably a lower weight than known systems. In further advantageous embodiments, a sole element is provided which has generally a better energy returning effect than known systems.

The general object is achieved by the subject-matter of the independent claims. Further advantageous embodiments follow from the dependent claims and the overall disclosure.

In a first aspect, the invention relates to a method for producing a sole element in particular a reinforced sole element. The method comprises the steps of:
a. providing a blank sole element, which comprises one or more, in particular a plurality of, tubular channel structures.
b. introducing, preferably injecting, a fiber composition into the one or more tubular channel structures, i.e. into the channels formed by the tubular channel structures. The fiber composition comprises, or consists of, fibers and a resin, in particular a flowable resin.
c. curing the introduced, preferably injected, fiber composition to provide the sole element, in particular the reinforced sole element.

The method according to the invention allows for a rapid and efficient method to produce a sole element. The sole element produced by this method may be considered as a reinforced sole element. A reinforced sole element is reinforced as compared to a sole element without the tubular channel structures defining channels which are filled with the fiber composition. The tubular channel structures can readily be arranged in the desired manner and can be reinforced by inserting the fiber composition. By arranging the tubular channel structure in the desired way, it can readily be predefined which areas of the sole element are reinforced by the cured fiber composition. In contrast to continuous plate elements, the reinforcement only occurs in predefined areas and thereby, the overall weight of the sole and therefore of a shoe is decreased. Furthermore, the tubular channel structures ensure that the reinforcement by the cured fiber compositions stays at the predefined locations and does not move, even during prolonged use.

The term “blank sole element” refers to a sole element whose tubular channel structures contain only air, e.g. at ambient pressure of 1 atm. and the fiber composition has not yet been introduced.

In some embodiments, the blank sole element provided in step a. further comprises a base body and the one or more tubular channel structures extend along the base body.

The term “extending along the base body” encompasses tubular channel structures which can be arranged within, adjacent to, on and/or below the base body. However, typically, the tubular channel structures are in direct contact with the base body.

In some embodiments, the blank sole element provided in step a. further comprises a blank base body and the one or more tubular channel structures extend along the blank base body. The blank base body is before or after step b. transformed into the base body. It is understood that such a transformation requires a physical and/or chemical modification of the blank base body. For example, the blank base body may be foamed to be transformed into the base body which is then foamed. The term “extending along the blank base body” encompasses tubular channel structures which can be arranged within, adjacent to, on and/or below the blank base body. However, typically, the tubular channel structures are in direct contact with the blank base body.

It is understood that the one or more tubular channel structures each define alone or together with the base body a corresponding channel. Each channel may have a channel volume. If a tubular channel structure defines a channel alone, then the channel walls are formed only by the tubular channel structure. In such embodiments, the tubular channel structure circumferentially delimits the channel with the exception of any channel openings. Channel openings as used herein typically refer to distal channel openings, which preferably define the start and/or end of the channel.

If a tubular channel structure defines a channel together with the base body, then the channel is delimited by the channel structure and the base body and thus, the channel walls are formed by the tubular channel structure and the base body. Also in such embodiments, the tubular channel structure together with the base body circumferentially delimits the channel with the exception of any channel openings. For example, the tubular channel structure may then have a U-shape or V-shape cross section, which together with the base body then results in an essentially rectangular or triangular channel cross section. Thus, the one or more tubular channel structures each define alone or together with the base body a cavity into which the fiber composition can be introduced.

Typically, each tubular channel structure defines alone or together with the base body two channel openings, i.e. a channel inlet and a channel outlet for introducing the fiber composition. Each tubular channel structure comprises typically at least one, at least two, at least three or at least four channel walls which define the corresponding channel alone or in combination with the base body. The channel walls of the tubular channel structure have typically a wall thickness t.

A flowable resin as used herein is a resin which has a viscosity being selected such that the resin can be injected into the one or more tubular channel structures. This may for example be a resin which is in its uncured state in a liquid form and which can be brought into a solid form, for example by heating and subsequent cooling, by chemical reaction and/or by irradiation. In particular, the flowable resin may be a molten resin.

Curing of the fiber composition may for example comprise curing of the resin. In particular, the resin may be solidified and/or hardened during curing. In some embodiments, curing may comprise cooling of a. the resin.

In some embodiments, curing may comprise heating the introduced fiber composition to or above a resin curing temperature of the resin. In certain embodiments curing may subsequently comprise cooling the heated resin. The curing temperature of the resin is the minimum temperature which is required to effect curing. In some embodiments, curing may comprise irradiation of the introduced fiber composition with light of a suitable wavelength.

In some embodiments, providing the blank sole element in step a. comprises sub-step a1.: producing the one or more tubular channel structures by additive manufacturing, blow molding or extrusion.

In some embodiments, also the base body or the blank base body is produced by additive manufacturing, blow molding or extrusion. In certain embodiments, the one or more tubular channel structures and the base body or the blank base body are integrally formed, i.e. they are produced as a single piece. In alternative embodiments, the one or more tubular channel structures and the base body or the blank base body are separately produced and then connected by suitable connection methods, such as welding, gluing or the like. It may also be possible that the base body or the blank base body defines a recess into which the tubular channel structures can be arranged, in particular under form-locking and/or force-locking engagement. While the tubular channel structures are produced before the step b. i.e. before injection of the fiber composition, it may be possible that the base body or the blank base body is either also produced before step b. or thereafter. Typically however during step b. the fiber composition is preferably injected into a channel being circumferentially delimited by the channel walls, with the exception of the at least two channel openings. Thus, the channels are preferably not grooves which are along their direction of extension open to the environment.

In preferred embodiments, the one or more tubular channel structures and optionally also the base body or the blank base body, are produced by additive manufacturing. Additive manufacturing may comprise any suitable 3D printing technique, such as SLS, FDM or the like. The use of additive manufacturing allows to easily individualize the produced sole element to the requirements of a specific individual. For example, the arrangement, number, dimension, shape, and other characteristics of the tubular channel structures can readily be adjusted by using additive manufacturing. Taken together with the injection and curing of the fiber composition, the design freedom is significantly increased, while maintaining an efficient production process. Combining additive manufacturing with steps a. to c. of the method according to the invention allows to rapidly provide reinforced and rigidified elements in the sole element in shapes and arrangements which would otherwise not or only hardly be possible to achieve.

In some embodiments, the one or more tubular channel structures are provided such that they extend at least in part along a longitudinal direction of the blank sole element and the produced sole element and/or such that they extend from a midfoot area into a forefoot area of the blank sole element and the produced sole element. In preferred embodiments, the one or more tubular channel structures may be arranged such that they extend from a heel area to the forefoot area via the midfoot area of the blank sole element and the produced sole element.

Directional indications as used in the present disclosure are to be understood as follows: The longitudinal direction L of the sole element is described by an axis from the heel area, respectively from the heel edge, to the forefoot region, respectively to the sole element tip, and thus extends along the longitudinal axis of the sole element. The transverse direction T of the sole element, extends transversely to the longitudinal axis and in the operative state substantially parallel to the ground. Thus, the transverse direction runs along a transverse axis of the sole element. In the context of the present invention, the vertical direction V is arranged in the operative state in the direction of the foot of the wearer, and thus runs along a vertical axis of the sole element. The longitudinal direction, the vertical direction and the transverse direction may all be perpendicular to each other. The lateral side of the sole element, is the outer perimeter of the sole element, between the heel edge and the sole element tip, which in the worn state rests against the outer instep of the wearer's foot. The medial side of the sole element, refers to the inner perimeter of the sole element, between the heel edge and the sole element tip, which is located opposite the lateral side. Thus, in a pair of worn shoes, the medial sides of the two shoes face each other and the lateral sides face away from each other. Furthermore, the sole element, may typically along the longitudinal direction be divided into a forefoot area, and a midfoot area and optionally also a heel area. If a heel area is present, the midfoot area is arranged between the forefoot area and the heel area.

In some embodiments, providing the blank sole element comprises performing a gait analysis and/or a foot analysis of an individual and producing the blank sole element according to the performed gait analysis and/or foot analysis. The blank sole element may then be provided, respectively produced based on the gait analysis and/or foot analysis. A foot analysis may for example comprise a 3D scan of the foot of the individual. A gait analysis may for example comprise monitoring the gait of the individual by a high speed camera or the use of pressure plates having force sensors. Such embodiments, may preferably be combined with embodiments in which step a. comprises sub-step a1. Thus, it may be possible to perform the gait and/or foot analysis of an individual and then produce the blank sole element by additive manufacturing, blow molding or extrusion, e.g. based on the gait and/or foot analysis.

The fibers of the fiber composition may in some embodiments be selected from one or more of carbon fibers, basalt fibers, aramid fibers, glass fibers, linen fibers and hemp fibers.

In some embodiments, the fibers may be endless fibers and/or fiber bundles, preferably fiber bundles of endless fibers.

In some embodiments, the blank sole element provided in step a. comprises a plurality of tubular channel structures which form a channel structure network. The channel structure network comprises at least two openings providing a fluidic communication between the inside of the plurality of tubular channel structures and the outside environment of the blank sole element. Typically, for each group of tubular channel structures which are in fluidic connection with each other, two openings per group are sufficient to introduce the fiber composition. In some embodiments, the majority or even all tubular channel structures of the channel structure network are in fluidic communication with each other.

In some embodiments, the blank sole element provided in step a. comprises a plurality of tubular channel structures. The plurality of tubular channel structures comprises a plurality of main channel structures and one or more connecting channel structures, wherein one or more connecting channel structures fluidic connect two or more main channel structures with each other.

In some embodiments, the fibers and the resin are in step b. introduced, particularly injected, simultaneously. This has the advantage that the fibers are efficiently transported into the channels by the resin.

In some embodiments, at least one of the one or more tubular channel structures comprises a branch at which the at least one tubular channel structure branches into two or more sub-channel structures. The branch may, for example, be a fork.

In some embodiments, the fiber composition is injected such that the tubular channel structures are filled by more than 90%, in particular more than 95%, more particular more than 98%, more particular by 100%, of their channel volume. It is understood that the channel volume refers to the volume of the channel before any fiber composition is introduced. The channel volume is typically defined, respectively delimited by the channel walls. The tubular channel structures are then filled by the fiber composition, in particular in these ranges.

In some embodiments, the one or more tubular channel structure may have an angular, such as rectangular, trapezoidal or triangular, or a round, particular ellipsoid or circular, cross-section. Unless noted otherwise, the term “cross-section” of a tubular channel structure, preferably refers to the plane being perpendicular to the channel extension direction, i.e. the direction along which the tubular channel structure extends.

In some embodiments, the one or channels formed by the tubular channel structures alone or together with the base body have an angular, such as rectangular, trapezoidal or triangular, or a round, particular ellipsoid or circular, cross-section. Unless noted otherwise, the term “cross-section” of a channel, preferably refers to the plane being perpendicular to the channel extension direction, i.e. the direction along which the channel extends.

In some embodiments, it may be possible that at least one of the tubular channel structures and/or the at least one channel defined by the tubular channel structures alone or in combination with the base body, has a cross-section which varies along the channel, i.e. along the particular channel. For example, it may be possible that the corresponding channel has in the midfoot area a rectangular cross-section and in the forefoot area a circular cross-section or vice versa.

In some embodiments, each channel defined by the tubular channel structures alone or in combination with the base body, may define a cross-sectional open area of between 2.5 mm² to 15.0 mm², in particular of 4.0 mm² to 10.0 mm². The term “open-area” refers to the surface area defined by the tubular channel structure and optionally the base body, i.e. by the channel walls and excludes any fiber composition within the tubular channel structure, respectively the channel.

In certain embodiments, the cross-sectional open area defined by one of the at least one tubular channel structures and optionally the base body, may vary along the channel.

In some embodiments, the height of the channel defined by the one or more tubular channel structures optionally the base body, is between 1.2 mm to 10.0 mm, in particular between 1.7 mm to 7.5 mm. The height of the channel may be the extension of the channel in the vertical direction.

In some embodiments the ratio of the channel height to the height of the base body, i.e. its extension along the vertical direction, is between 5:1 and 1:1, in particular between 21:5 and 9:8.

In some embodiments, the width of the channel defined by the one or more tubular channel structures is between 1.2 mm to 20.0 mm, in particular between 1.7 mm to 7.5 mm. The width is perpendicular to the direction along which the tubular channel extends and may be the extension of the channel in the transversal direction.

In some embodiments the ratio of the channel width to the total width of the sole element, i.e. its extension along the transverse direction, is between 1:1 and 85:1, in particular between 3:1 and 21:1.

The height and width of the channel are typically within the cross-sectional plane being perpendicular to the extension direction of the corresponding channel and/or tubular channel structure.

In some embodiments, the height and/or width of the channel defined by one of the at least one tubular channel structures and optionally the base body, may vary along the channel.

In some embodiments, the blank sole element and the produced sole element comprises one, two, three, four, five or six separate tubular channel structures. Separate tubular channel structures are not fluidic connected to each other. In certain embodiments, the blank sole element and the produced sole element comprises only one, only two, only three, only four, only five or only six separate tubular channel structures.

In some embodiments, the base body comprises, respectively defines, a plurality of through going holes, i.e. holes which extend through the base body. The total open area defined by the sum of the open area defined by each hole, is between 0% and 90%, in particular between >0% and 90%, more particular between 10% and 75% of the total surface area of the base body.

The one or more tubular channel structures and the base body may be made from a material selected from one or more of: thermoplastic polyurethanes (TPU), thermoplastic elastomers, polyamides, polyether block amide, ethylene vinyl acetate, polyvinylidene fluoride, polyolefins and polyesters.

The one or more tubular channel structures and the base body may be made from the same material or from different materials.

In some embodiments, the sole element may be a sole plate. In certain embodiments, the sole plate may be a rigid sole plate. For example, the sole plate may be an elastic and incompressible sole plate.

In some embodiments, the sole plate extends at least from a midfoot area to the forefoot area and has a tip. The tip typically coincides with the tip of a shoe for which the sole plate may be used. Thus, the tip is in the worn state in the longitudinal direction arranged in front of the toes of the wearer. In certain embodiments, the sole plate extends from the heel area through the midfoot area to the forefoot area. In such embodiments, the sole plate has a heel edge. The heel edge is the part which along the longitudinal direction has the largest distance to the tip. In embodiments, in which the sole plate only extends from the midsole area to the forefoot area (and thus not in the heel area), the sole plate has accordingly a midfoot edge. Also in this case, the midfoot edge is the part which along the longitudinal direction has the largest distance to the tip.

In some embodiments, the sole element obtained, in particular the sole plate, has a bending modulus as determined by Test Method 1 of at least 12000 N/mm², in particular at least 15000 N/mm², more particular at least 20000 N/mm². In some embodiments, the sole element, in particular the sole plate, has a bending modulus as determined by Test Method 1 of at most 70000 N/mm², in particular at most 60000 N/mm², more particular at most 55000 N/mm². Such a bending modulus provides a stable stand and an efficient push-off.

According to Test Method 1, a 3-point bending test is performed (for the 3-point bending test see https://en.wikipedia.org/wiki/Three-point_flexural_test and DIN EN ISO 178:2019). For this, a sole element, in particular a sole plate, is positioned with its base layer on two support pins which extend over the complete transverse direction of the sole element, in particular the sole plate. The sole element, in particular the sole plate, used may generally be a US size 10 sole plate and may have a length of 262 mm. The two support pins are spaced apart from each other with a distance of 160 mm. Each support pin has a width (extension along the transverse direction of the sole plate during the measurement) of 70 mm and has a rounded edge with a curve radius of 25 mm which supports the sole element, in particular the sole plate. Then a loading pin is arranged on the top layer at 70% of the total length of the sole element, in particular the sole plate, measured from the heel edge to the tip. The loading pin has a width (extension along the transverse direction of the sole element, in particular the sole plate during the measurement) of 70 mm and a rounded half cylindrical edge which pushes on the sole element, in particular the sole plate, having a curve radius of 25 mm. The loading pin is arranged in the longitudinal direction between the two support pins. The front support pin, i.e. the support pin which is closer to the tip of the sole element, in particular the sole plate, is in the longitudinal direction spaced 80 mm apart from the loading pin (measured from the poles of the pins); and the back support bin, i.e. the support pin which is arranged closer to the heel edge, respectively the midfoot edge, of the sole element, in particular the sole plate, is in the longitudinal direction spaced 80 mm apart from the loading pin (measured from the poles of the pins). All three pins arranged on a longitudinal center line of the sole element, in particular the sole plate, i.e. the extension of each pin in the transverse direction towards the lateral peripheral edge and towards the medial peripheral edge is essentially the same. Then, the loading pin is preloaded with a preforce of 10 N (F₀) if a sole element, in particular a sole plate is tested, or with a preforce of 25 N (F₀) if a whole shoe with an upper is tested and then gradually (5 times) loaded with a force which bends the sole element, in particular the sole plate, and the force (F₁) is measured which is required for deflect the sole element, in particular the sole plate, by 15 mm in the vertical direction to measure the corresponding force (test speed: 300 mm/min). By the formula E=l³ᵥΔF/(4D_{L}ba³) the bending modulus can be determined, wherein ΔF is the difference in Newton between the end of the measurement (F₁) and the begin of the measurement (F₀); lᵥ is the support span width in mm; D_{L} is the bending distance between F₁ and F₀ in mm; b is width of the sample at the position of the loading pin in mm and a is the thickness of the sample at the position of the loading pin in mm.

In embodiments in which the sole element, in particular the sole plate, comprises more than one tubular channel structure, the tubular channel structures may generally be preferably spaced apart from each other. Preferably, at least two tubular channel structures are in the transverse direction spaced apart from each other. In certain embodiments, at least a portion of the base body may be arranged between the tubular channel structures being spaced apart from each other. It may in some embodiments be possible that the one or more tubular channel structures are each arranged between two portions of the base body.

In some embodiments of the sole plate, the base body and the one or more tubular channel structures are made from the same material. Alternatively, it may be possible that they are made from a different material.

In alternative embodiments, the sole element may be a midsole. It may be possible that the tubular channel structure and the base body are integrally formed. In some embodiments of the sole element being a midsole, the base body and/or the tubular channel structure may be made from a polymer foam.

In alternative embodiments of a sole element being a midsole, the one or more tubular channel structures are separate from the base body. For example, the base body may be made from a polymer foam. The tubular channel structure may be made from the same or another material, in particular polymer material, however may preferably be non-foamed. The polymer foam structure and the one or more tubular channel structures are thus not integrally formed. In some embodiments, the polymer foam structure at least partially, or fully, surrounds the one or more tubular channel structures. It is understood that this however excludes the openings of the tubular channel structures. It may for example be possible that the base body, being a polymer foam element, defines a groove or recess into which the tubular channel structure(s) can be arranged, in particular under a force-locking and/or form-locking engagement.

In certain embodiments in which the sole element is a midsole, step a. may comprise the formation of the tubular channel structures and a blank base body. The blank base body is then in a subsequent sub-step transformed into the base body, i.e. the finished base body. This base body and the whole blank sole element is then used in step b. For example, it may be possible to manufacture the blank base body and the one or more tubular channel structures together or separately. The blank base body may be manufactured such that it is foamable. For example, it may be possible to include a blowing agent into, preferably only into, the blank base body. In a subsequent step, the blank base body may be foamed to provide the polymer foam structure. For example, and as outlined further above, the blank base body and the one or more tubular channel structures may be formed by additive manufacturing. In alternative embodiments, step a. only comprises the formation of the tubular channel structures, in particular from a foamed polymer material. Then step b. is performed, i.e. the fiber composition is injected into the tubular channel structures to fill the channels defined by the tubular channel structures. Thereafter, e.g. before or after curing, the tubular channel structures are connected to a base body, such as the polymer foam element.

In a second aspect, the invention relates to a sole element and in particular a sole element which is obtained by the method as described in any of the embodiments herein, in particular with respect to the first aspect of the invention.

It is generally understood that the embodiments and features described herein with respect to the method according to any of the embodiments of the first aspect of the invention may preferably also apply to embodiments of the second aspect of the invention. Vice versa, the embodiments and features described herein with respect to the sole element according to any of the embodiments of the second aspect of the invention may preferably also apply to embodiments of the method according to any of the embodiments of the first aspect of the invention.

The sole element comprises one or more tubular channel structures. Furthermore, a cured fiber composition, which comprises, or consists of, fibers and a resin, is introduced, preferably injected, into the one or more tubular channel structures, respectively into channels formed by the one or more tubular channel structures. The cured fiber composition is therefore arranged within the one or more tubular channel structures, respectively the channels. The sole element is preferably a reinforced sole element.

In some embodiments, the sole element further comprises a base body and the one or more tubular channel structures extend along the base body.

In some embodiments, the one or more tubular channel structures protrude from the base body. Preferably, the one or more tubular channel structures protrude in the vertical direction from the base body.

In some embodiments, the one or more tubular channel structures have at least one, at least two, at least three or at least four channel walls, which each have a wall thickness t. The channel walls define alone or in combination with the base body a channel with maximum channel width w. The maximum channel width is perpendicular to the direction along which the channel extends and defines the maximum distance of opposing channel wall sections. For circular cross-sections, the maximum channel width is for example given by the channel diameter.

In certain embodiments, the ratio of t:w is between 1:150 to 1:3, in particular 1:75 to 2:7, more particular 1:50 to 1:4.

In some embodiments, the tubular channel structures, respectively the channels, are filled by more than 90%, in particular more than 95%, more particular more than 98%, more particular by 100%, of their channel volume with the cured fiber composition.

In some embodiments, the resin of the cured fiber composition is directly material bonded to the one or more tubular channel structures and optionally the base body. Directly material bonded means that no additional adhesive is used. For example, the uncured fiber composition can be inserted into the one or more tubular channel structures, respectively the channels defined by them, as explained with respect to the first aspect of the invention. Curing then also encompasses the formation of a direct material bonding between the resin and the one or more tubular channel structures and optionally the base body. This securely connects the fiber composition and maintains it in place even during prolonged and extensive use in a shoe. It is understood that even though there is a material bonded connection, the tubular channel structures and the cured fiber composition are not integral to each other, i.e. they are preferably differentiable from each other. For example, it may be possible that the one or more tubular channel structures and the cured fiber composition, in particular the resin of the fiber composition, are different materials and/or have different physical properties, such as hardness or density. Preferably, the resin is directly material bonded to the one or more tubular channel structures and optionally the base body over at least 90%, in particular at least 95%, more particular at least 99% or even 100% of the length of each tubular channel structure.

In some embodiments, the sole element comprises a plurality of tubular channel structures. The plurality of tubular channel structures may in certain embodiments comprise main channel structures and one or more connecting channel structures, which connect two or more of the main channel structures which each other. The main channel structures and the connecting channel structures may for example define a channel structure network. It is understood that connected channels are channels in which the cured fiber composition being arranged in the channels continuously extends through the connected channels.

In some embodiments, the sole element comprises a plurality of tubular channel structures which form a channel structure network. At least some, or even all, tubular channel structures of the tubular channel network are connected with each other.

As outlined above, with respect to the first aspect of the invention, the sole element may be a sole plate, in particular a rigidifying sole plate, i.e. a sole plate which is configured to rigidify a sole of a shoe. Alternatively, the sole element may be a midsole.

In embodiments in which the sole element is a sole plate, the weight of the plate element may preferably be between 10 g to 40 g, in particular between 15 g and 35 g. In some embodiments, the average density of the sole plate may be 0.8 g/cm³ to 3 g/cm³, in particular 0.9 g/cm³ to 2.5 g/cm³.

In some embodiments, the surface area of the base body along which the one or more tubular channel structures extend is between 3% to 85%, in particular 5% to 60%, of the total surface area of the sole element. The total surface area is defined as the surface area of one of the sides of the sole element. The sole element has in the vertical direction a top side and a bottom side. In the worn or operative state, the bottom side faces towards the ground and the bottom side faces towards the foot of the wearer. Thus, the total surface area refers to the surface area of one of these sides, typically the side along which the one or more tubular channel structures extend.

In some embodiments, the sole element and in particular the sole plate, comprises in the forefoot area or midfoot area a bent in the vertical direction. In other words, the forefoot area may be inclined with respect to the midfoot area and optionally the heel area.

According to a third aspect, the invention relates to a shoe with a sole element according to any of the embodiments as described herein, in particular with respect to the second aspect. In some embodiments, the shoe comprises a sole structure comprising such a sole element and an upper being connected to the sole structure. The upper and the sole structure typically define a foot accommodation compartment.

### BRIEF DESCRIPTION OF SEVERAL VIEWS OF THE DRAWINGS

The herein described invention will be more fully understood from the detailed description given herein below and the accompanying drawings which should not be considered limiting to the invention described in the appended claims.

FIG. 1 shows a perspective view of a sole element 1 according to an embodiment of the invention;

FIG. 2 shows a cross-sectional view perpendicular to longitudinal direction L and within the plane defined by the transversal direction T and vertical direction V of a sole element according to another embodiment of the invention;

FIG. 3 shows a top view of a sole element according to another embodiment of the invention;

FIG. 4 shows a schematic view of a sole element according to another embodiment of the invention;

FIG. 5 shows a schematic view of a sole element according to another embodiment of the invention;

FIG. 6 shows a schematic view of a sole element being a midsole according to another embodiment of the invention;

FIG. 7 shows a cross-sectional view perpendicular to longitudinal direction L and within the plane defined by the transversal direction T and vertical direction V of a sole element according to another embodiment of the invention;

FIG. 8 shows a schematic view of a sole element being a midsole according to another embodiment of the invention;

FIG. 9 shows a schematic view of a sole element being a midsole according to another embodiment of the invention; and

FIG. 10 shows the results of a bending modulus test of a sole plate according to the invention and comparison to a standard sole plate.

### DETAILED DESCRIPTION OF THE INVENTION

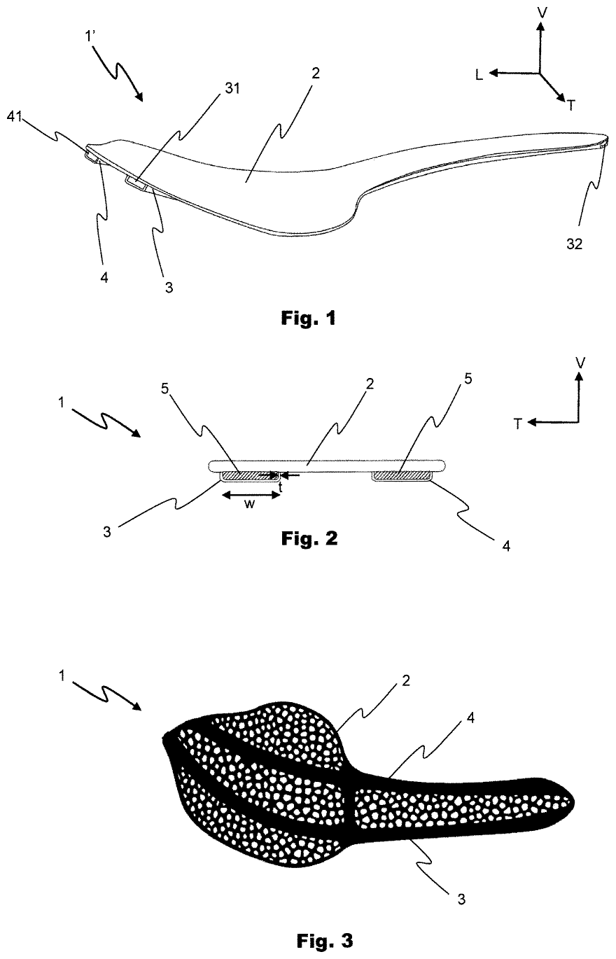

FIG. 1 shows a blank sole element 1′, from which a sole element 1 can be produced being a sole plate. Blank sole element 1′ comprises base body 2 and two tubular channel structures 3 and 4 which essentially extend in parallel along base body 2 on the bottom side of sole element 1. Tubular channel structures 3 and 4 extend along longitudinal direction L and have in the cross-section being perpendicular to the longitudinal direction L (i.e. in the V, T plane) a rectangular shape. Tubular channel structures 3 and 4 each have two openings 31, 32 and 42 (the second opening of tubular channel 4 is not visible in this perspective view) being arranged at opposite ends of the corresponding tubular channel structure. During manufacture, a fiber composition is introduced from one of the openings of each tubular channel structure, e.g. opening 31 into the corresponding tubular channel structure and is transported from there up to the second opening 32. The fiber composition comprises a resin and fibers. If the resin is in a flowable or liquid state, the resin transports the fibers into the channel defined by tubular channel structure 3 and evenly distributes the composition therein. The blank sole element 1′ shown extends from a heel area through a midfoot area into a forefoot area.

FIG. 2 shows a cross-sectional view of a sole element 1 according to another embodiment. The cross-section is perpendicular to the extension direction of the corresponding channel which is in this embodiment longitudinal direction L. Furthermore, the cross-section lies in the plane defined by vertical direction V and transversal direction T. Sole element 1 comprises base body 2 and again two tubular channel structures 3 and 4. As can be seen, cureable or cured fiber composition 5 is introduced into the tubular channel structures 3 and 4 and the corresponding channels are completely filled with cureable or cured fiber composition 5. Each channel structure has a channel wall with wall thickness t and defines the corresponding channel with maximum channel width w.

FIG. 3 shows another embodiment of sole element 1 in which base body 2 comprises, respectively delimits a plurality of through-going openings which decrease the overall weight of the sole element. Since the desired rigidifying effect is primarily achieved by the cureable or cured fiber composition being inserted in tubular channel structures 3 and 4, it is possible to achieve a relatively large open area defined by the through-going openings without losing any rigidifying effect.

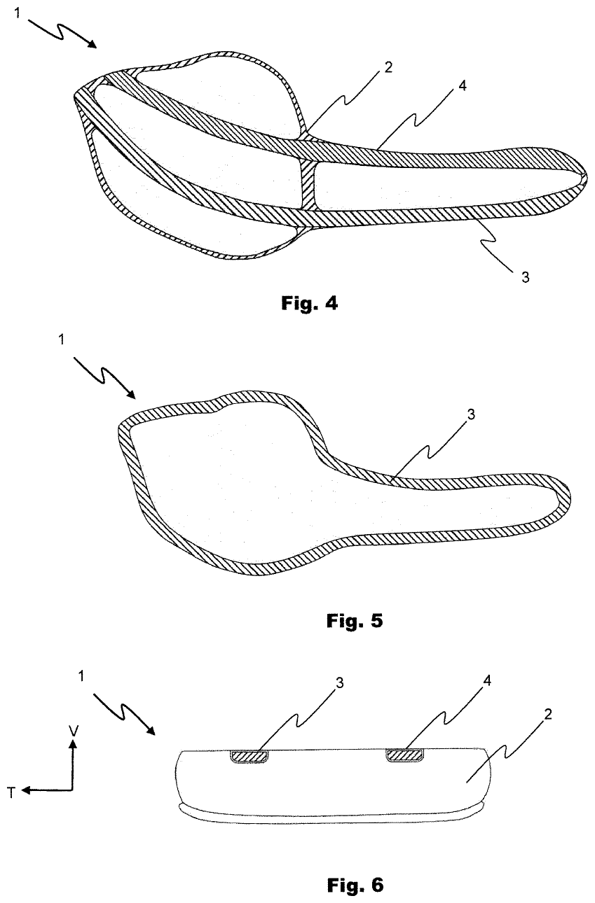

FIG. 4 shows another embodiment of sole element 1 in which base body 2 comprises, respectively delimits a plurality of through-going openings. Furthermore, the sole element comprises two tubular channel structures 3 and 4 which extend from a heel area of the sole element to the tip of the sole element along its longitudinal direction.

FIG. 5 shows a different embodiment of a sole element 1 according to the invention. In this embodiment, the sol element essentially consists of a single tubular channel structure. It should be noted that the channel openings are arranged on the back side and in this view not visible. In this or any other embodiment as described herein, the tubular channel structure may peripherally delimit the sole element 1.

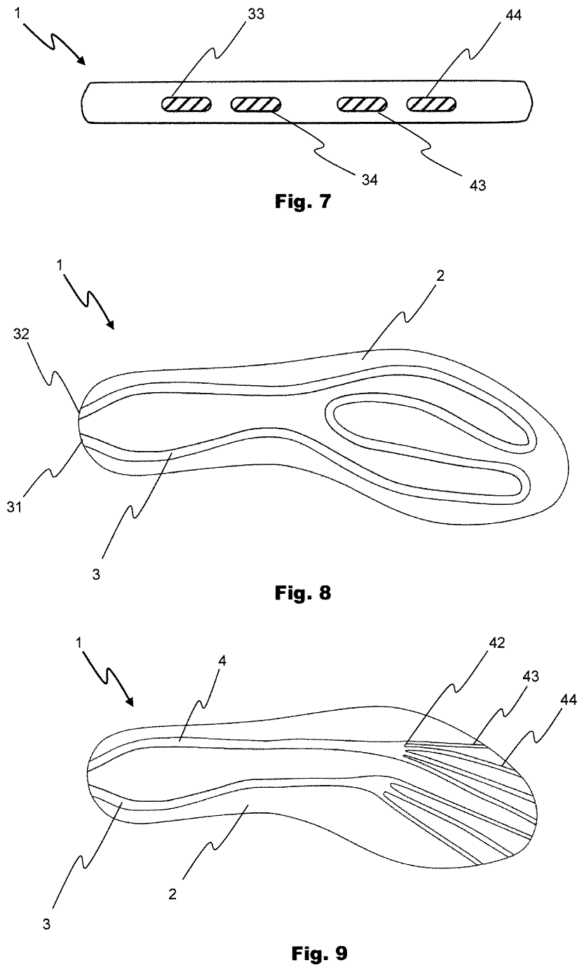

FIG. 6 shows another embodiment of a sole element 1. In contrast to the embodiments shown, for example in FIG. 2, 3 or 4, the sole element 1 is not a sole plate, but a midsole. This sole element comprises base body 2 which may be made from a polymer foam. Base body 2 defines two grooves within which tubular channel structures 3 and 4 are arranged. As can be seen, both channels defined by tubular channel structures 3 and 4 are filled with the fiber composition.

FIG. 7 shows another sole element 1 according to the invention. In this embodiment, a cross sectional view is shown and it can be seen that sole element 1 comprises two tubular channel structures. As it is for example also shown in FIG. 9 below, each one of the tubular channel structures branches into two sub-channel structures, i.e. sub channel structures 33 and 34 and sub-channel structures 43 and 44. Such embodiments may for example be made from a midsole which has one or more tubular channel structures defining void channels, into which a fiber composition in injected.

FIG. 8 shows another embodiment of a sole element 1 as a cross-sectional view in the transversal and longitudinal direction. In this embodiment, sole element 1 comprises only a single tubular channel structure 3 extending along base body 2. Both openings 31 and 32 of tubular channel structure 3 are arranged in the heel area at the heel edge of sole element 1. In the forefoot area, at least one of the tubular channels structures, in this embodiment tubular channel structure 3, may in this or any other embodiments as described herein form a meander structure.

FIG. 9 shows an alternative embodiment with two tubular channel structures 3 and 4. Both tubular channel structures comprise a branch, such as branch 42 at which the corresponding tubular channel branches into a plurality of sub-channel structures, such as sub-channel structures 43 and 44 (only two sub-channel structures are referenced for clarity purposes).

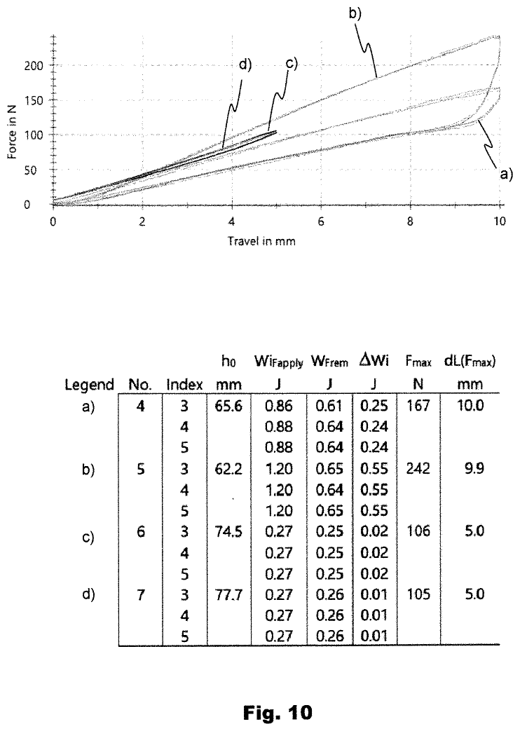

FIG. 10 shows the measurement results of the bending modulus and the energy return of a sole plate according to the invention [a) and d)], such as the one shown in FIG. 3, as well as of a continuous plate element according to the prior art, which is a continuous plate extending essentially completely over the complete forefoot area, midfoot area and the heel area. Measurements a) and b) are conducted in the forefoot/midfoot area as described herein with respect to Test Method 1. Measurements c) and d) are comparative measurements in the heel area. It can be seen that while the bending modulus of the continuous plate in the forefoot/midfoot area is higher [24.4 N/mm², see b)] than for the sole element according to the invention [16.7 N/mm², see a)], the energy return W_{Frem}/W_{Fapply} is much higher for the sole element according to the invention [72%, see a)] than for the continuous sole element [54%, see b)]. Since this energy return is most important in the forefoot/midfoot area, where the sole plate is bent during running, FIG. 6 demonstrates that a better energy return can be achieved by the method and sole element according to the invention. Furthermore, the energy return can readily be adjusted by changing the size, dimension, shape, position and/or number of tubular channel structures.

1. A method for producing a sole element for a shoe, the method comprising the steps:
a. providing a blank sole element comprising one or more tubular channel structures;
b. introducing a fiber composition into the one or more tubular channel structures, the fiber composition comprising fibers and a resin;
c. curing the introduced fiber composition.

2. The method according to claim 1, wherein the blank sole element provided in step a. further comprises a base body and wherein the one or more tubular channel structures extend along the base body.

3. The method according to claim 1, wherein the blank sole element provided in step a. further comprises a blank base body and wherein the one or more tubular channel structures extend along the blank base body wherein the blank base body is before or after step b. transformed into a base body.

4. The method according to claim 1, wherein step a. comprises sub-step a1.: producing the one or more tubular channel structures by additive manufacturing, blow molding or extrusion.

5. The method according to claim 1, wherein the one or more tubular channel structures extend at least in part along a longitudinal direction of the sole element.

6. The method according to claim 1, wherein step a. comprises performing a gait analysis and/or foot analysis of an individual and producing the sole element according to the gait analysis and/or foot analysis.

7. The method according to claim 1, wherein the fibers are endless fibers and/or wherein the fibers are selected from one or more of carbon fibers, basalt fibers, aramid fibers, glass fibers, linen fibers and hemp fibers.

8. The method according to claim 1, wherein the blank sole element provided in step a. comprises a plurality of tubular channel structures which form a channel structure network, wherein the channel structure network comprises at least two openings providing a fluidic communication between the inside of the plurality of tubular channel structures and the outside environment of the sole element.

9. The method according to claim 1, wherein the blank sole element provided in step a. comprises a plurality of tubular channel structures and wherein the plurality of tubular channel structures comprises a plurality of main channel structures and one or more connecting channel structures, wherein one or more connecting channel structures fluidically connect two or more main channel structures with each other.

10. The method according to claim 1, wherein in step. b. the fibers and the resin are introduced simultaneously.

11. The method according to claim 1, wherein at least one of the one or more tubular channel structures comprises a branch at which the at least one tubular channel structure branches into two or more sub-channel structures.

12. The method according to claim 1, wherein the fiber composition is injected such that the tubular channel structures are filled by more than 90% of their channel volume.

13. A sole element comprising one or more tubular channel structures, wherein a cured fiber composition which comprises fibers and a resin is provided into the one or more tubular channel structures.

14. The sole element according to claim 13, further comprising a base body, wherein the one or more tubular channel structures extend along the base body.

15. The sole element according to claim 14, wherein the one or more tubular channel structures protrude from the base body.

16. The sole element according to claim 13, wherein the one or more tubular channel structures have a channel wall with a wall thickness t, wherein the channel wall defines a channel with maximum channel width w, wherein the ratio of t:w is between 1:150 to 1:3.

17. The sole element according to claim 13, wherein the resin of the cureable fiber composition is directly material bonded to the one or more tubular channel structures.

18. The sole element according to claim 13, wherein the sole element comprises a plurality of tubular channel structures (3, 4), wherein the plurality of tubular channel structures comprises main channel structures and one or more connecting channel structures, wherein one or more connecting channel structures connect two or more main channel structures with each other.

19. The sole element according to claim 13, wherein the sole element comprises a plurality of tubular channel structures which form a channel structure network, wherein at least some of the tubular channel structures of the channel structure network are connected with each other.

20. The sole element according to claim 13, wherein the sole element is a sole plate or a midsole.
